(19) United States
(12) Patent Application Publication
(10) Pub. No.: US 2026/0181248 A1
(43) Pub. Date: Jun. 25, 2026

(54) HANDHELD SCANNING APPARATUS

(71) Applicant: Empowering Tech Ltd., Seend (GB)

(72) Inventor: Theodore Davies, Seend (GB)

(21) Appl. No.: 19/426,029

(22) Filed: Dec. 18, 2025

(30) Foreign Application Priority Data
Dec. 19, 2024 (GB) 2418650.4

(51) Int. Cl. H04N 23/60; H04N 23/50

(52) U.S. Cl. CPC H04N 23/64; H04N 23/50

(57) ABSTRACT

A handheld scanning apparatus 100, comprising a body 110, a camera configured to scan images, two actuators 130, 140, each having a distal end projecting from a first end of the body, each distal end arranged to contact a surface, each of the actuators independently moveable relative to the body in dependence of the distance of the first end of the body from the surface, a position detector for determining the position of each of the actuators relative to the body, and an indicator for providing an indication of the position of the body relative to the surface. In this way, a user is provided with an indication as to whether or not they are holding the body at a desired position relative to the surface.

### CROSS-REFERENCE TO RELATED APPLICATIONS

This application claims priority to British Application No. GB2418650.4 filed Dec. 19, 2024, which is hereby incorporated by reference in its entirety.

### BACKGROUND OF THE INVENTION

The present invention relates generally to a handheld scanning apparatus and finds particular, although not exclusive, utility in scanning text and converting it to an audible signal.

Handheld scanners comprising cameras are known. In use, such a handheld scanner is moved over a surface and the camera captures images of each part of the surface as it moves over it. The captured images may then be combined to reconstruct a complete image of the surface, manipulated and/or reproduced in some other way, or analysed for particular features. For example, where a captured image contains text, known text recognition procedures may be carried out on the captured image to produce an audible signal which reads the text to a user.

In order to ensure a reasonable quality of captured images (e.g. images in which text can be recognised), it is important that the scanner is held at a correct position relative to the surface being scanned. For example, the camera needs to be positioned relatively close to the surface being scanned and in such a way that it is able to capture clear images of text, for example.

However, a user may hold the scanner in a position relative to the surface which is not optimal for the capture of clear images. Alternatively, a user may repeatedly change the position of the scanner relative to the surface. This may lead to the quality of the captured images being poor and/or inconsistent, which may lead to the subsequent processing of the images (for instance for character recognition) not being possible or leading to incorrect processing results.

Accordingly, there is a need for a hand-held scanning apparatus which addresses this problem.

### SUMMARY OF THE INVENTION

In a first aspect, the present invention provides a handheld scanning apparatus for scanning images and converting them into a different format, the handheld scanning apparatus comprising a body; a camera arranged in the body configured to scan images, in use, when a first end of the body is held closely adjacent, or in contact with, a surface comprising an image to be scanned; two actuators, each having a distal end projecting from the first end of the body, the distal end arranged to contact the surface, in use, when the body is held closely adjacent, or in contact with, the surface, each of the actuators independently moveable relative to the body in dependence of the distance of the first end of the body from the surface; a position detector for determining the position of each of the actuators relative to the body; and an indicator configured to provide an indication that the position of the body relative to the surface, in use, either meets or does not meet pre-defined criteria, on the basis of the position of each of the actuators relative to the body.

The aim is that the position of the body relative to the surface, in use, meets the predefined criteria to allow for optimum image capture. When character recognition is desired, this aids such a process.

In this way, a user is provided with an indication as to whether or not they are holding the body at the correct position relative to the surface. In use, a user may then re-align the position of the body relative to the surface.

Converting scanned images into a different format may involve manipulating, processing and/or encoding the scanned images to produce an output that is different to the original image captured by the camera. For example, where an image contains text, converting the image into a different format may involve generating an audio output signal based on the text; converting the image into a string of text; and/or generating a new image in which the text has been translated into a different language.

The position detector may comprise two microswitches, a first microswitch actuated by the movement of one of the two actuators towards the body beyond a first threshold distance, and a second microswitch actuated by the movement of the other of the two actuators towards the body beyond a second threshold distance.

The pre-defined criteria may comprise the requirement that both microswitches are actuated.

For example, the position detector may comprise the two microswitches in combination with an electrical or electronic circuit (including, for instance, other discrete components such as resistors and transistors), arranged to activate, or deactivate, an indicator device or indicator circuit when both microswitches are actuated.

The first and second threshold distances may be equal to one another or not equal to one another.

The first and second threshold distances may be in the range 0.5 mm to 10 mm. Other distances are contemplated.

More particularly, the first and second threshold distances may be in the range 2 to 10 mm.

The indicator may be configured to provide an indication in one or more of an audible, haptic, and visual manner.

For example, the indicator may comprise one or more of a buzzer, a loudspeaker, a vibrator (e.g. an eccentric rotating mass motor), an LED and a lamp. The indicator may be configured to provide an indication in a first manner when the position of the body relative to the surface meets the pre-defined criteria, and an indication in a second manner when the position of the body relative to the surface does not meet the pre-defined criteria.

Alternatively, the indicator may be configured to only give an indication when the position of the body relative to the surface meets the pre-defined criteria and to not give such an indication when the position of the body relative to the surface does not meets the pre-defined criteria, or to give an indication only when the position of the body relative to the surface does not meet the pre-defined criteria and to not give such an indication when the position of the body relative to the surface meets the pre-defined criteria. That is, a lack of any indication from the indicator may in itself be an indication.

The handheld scanning apparatus may further comprise a display screen.

The display screen may be configured to display images captured by the camera and/or information about said images (e.g. text recognised within the image). The display screen may additionally be configured to provide an indication as to whether or not the position of the body relative to the surface meets the pre-defined criteria.

The handheld scanning apparatus may further comprise a processor configured to process the images scanned by the camera.

Processing the images scanned by the camera may comprise manipulating the images (e.g. resizing, cropping, rotating, recolouring, adjusting the contrast), combining multiple images, compressing the images and/or analysing the images to identify patterns, features, text etc. Processing the images scanned by the camera may comprise use of optical character recognition methods.

The processor may be further configured to determine whether the position of the body relative to the surface, in use, meets the pre-defined criteria. Other sensors may be provided to assist in this determination such as one or more accelerometers, gravitometers, gyroscopes and/or inertial measurement units.

In this way, the size of the handheld scanning apparatus may be reduced, as the need for a separate electronic circuit comprising discrete components for determining whether the position of the body relative to the surface meets the pre-defined criteria is removed.

The processor may be configured to only process the images scanned by the camera when the position of the body relative to the surface, in use, meets the pre-defined criteria.

In this way, power and computational resources can be saved as the processor does not attempt to process poor quality image data captured when the position of the body relative to the surface does not meet the pre-defined criteria.

Each actuator may comprise a relatively thin prong (or pin). Each prong may be between 5 mm and 50 mm in length. More particularly, each prong may have a length between 10 mm and 30 mm; for example, approximately 20 mm.

Each prong may be arranged partially inside the body. For example, each prong may comprise a first portion extending from a distal end, outside of the body, towards the first end of the body, and a second portion extending from the first portion, through the body, to a proximal end inside the body. The first portion of each prong may have a length (as measured from the distal end of the prong to the first end of the body) between 0.5 mm and 5 mm; for example, approximately 2 mm. The first portion of each prong may have a maximum width, measured perpendicular to its length, between 1 mm and 10 mm; for example, approximately 5 mm.

A portion of each prong towards its respective distal end, and including the first portion, may be substantially prism-shaped, having a constant cross section along its longitudinal length. For example, a portion of each prong towards its respective distal end may be substantially cuboid shaped. However, other cross-sectional shapes are contemplated, such as a circle or a triangle.

The distal end of each prong may comprise a curved or domed surface. The distal end of each prong may not comprise any sharp corners. In this way, damage to the surface may be minimised, in use.

In use, when a distal end of a prong is in contact with the surface, the force exerted on the prong by the surface may cause the prong to move inwardly towards the body. Where the position detector comprises two microswitches, the microswitches may be arranged inside the body so that the proximal end of one of the prongs moves towards, and thereby actuates, one of the microswitches when that prong moves inwardly towards the body, and the proximal end of the other one of the prongs moves towards, and thereby actuates, the other one of the microswitches when that other prong moves inwardly towards the body.

Each prong may be arranged with its longitudinal length parallel to the optical axis of the camera, and may be configured to move relative to the body in a direction parallel to the optical axis of the camera.

In this way, the position of the body relative to the surface meets the pre-defined criteria when any imaginary straight line extending from a first point on one of the two prongs to a point on the other of the two prongs such that the line is perpendicular to the longitudinal lengths of both prongs, is parallel to the plane in which the surface lies. Put another way, the position of the body relative to the surface meets the pre-defined criteria when the plane in which the optical axis (of the camera) lies, which is perpendicular to the plane in which the longitudinal lengths of the prongs lie, is also perpendicular to the plane in which the surface. It is to be understood that, if the surface is curved, the plane in which the surface lies may be taken to be the plane that is tangent to the surface at the point where the optical axis intersects the surface.

The camera may be arranged in the body between the two prongs.

The handheld scanning apparatus may further comprise biasing means for biasing the prongs outwardly away from body.

In this way a prong will move outwardly away from the body when it is not in contact with the surface, or when the first end of the body is moved away from the surface. This will prevent a situation in which a prong that was previously in contact with the surface ceases to be in contact with the surface but does not move outwardly away from the body, thus cancelling any activation of the microswitch, resulting in a user being provided with a false indication that they are holding the body in a position, relative to the surface, that meets the pre-defined criteria.

The handheld scanning apparatus may be configured to switch off or enter a sleep mode/power-saving mode when neither prong is in contact with the surface. In this way, power consumption can be reduced.

The biasing means may comprise at least one spring.

The spring may comprise a coil spring, a leaf spring, a torsion spring or a resiliently compressible member.

The position detector may comprise a first linear displacement sensor actuated by the movement of one of the two actuators towards the body beyond a first threshold distance, and a second linear displacement sensor actuated by the movement of the other of the two actuators towards the body beyond a second threshold distance. The first and/or second linear displacement sensor may be a non-contact sensor that uses inductive, capacitive, magnetic, optical and/or acoustic technology to measure physical phenomena indicative of a displacement or change of position of an actuator. For example, the first and/or second linear displacement sensor may comprise a coil arranged around a part of an actuator comprising a magnet. The linear displacement of the actuator can then be determined based on the electric current induced in the coil.

It is to be appreciated that the first and second linear displacement sensor may be present in the handheld scanning apparatus in combination with any one or more of the abovementioned features.

Other types of actuators and means of actuating microswitches are contemplated. For example, each actuator may comprise a deformable hemispherical shell projecting from the first end of the body and enclosing a first end of a respective air sac, the respective air sac configured to press against a respective microswitch in response to the hemispherical shell being compressed inwardly toward the first end of the body. Alternatively, pressure sensors configured to measure the pressure within each air sac may be used instead of microswitches.

Another possibility is the provision of a rotary potentiometer rotated by a lever, where the lever is acted upon at each end by the two actuators. An electrical circuit may be provided to interpret the resistance created by the potentiometer and activate/deactivate the indicator in accordance with pre-defined criteria. This may allow for ranges of relative positions of the two actuators being deemed to meet the pre-defined criteria.

In the above discussion, the term “position”, with regard to the position of the body relative to the surface, may include the angle of the longitudinal length of the body and/or the camera's optical axis relative to the plane of the surface immediately adjacent the camera in three axes, each perpendicular to the other two. The term “position”, used with regard to the position of the actuators, may include the linear displacement of either or both of the actuators relative to the body along a direction parallel to the longitudinal length of the body and/or the optical axis of the camera.

In a second aspect, the present invention provides a method of scanning images and converting the images into a different format, the method comprising the steps of: providing the handheld scanning apparatus of the first aspect; holding the body of the apparatus closely adjacent, or in contact with, a surface comprising an image; the apparatus determining the position of each of the actuators relative to the body; and the apparatus providing an indication that the position of the body relative to the surface either meets, or does not meet, pre-defined criteria, on the basis of the position of each of the actuators relative to the body.

It is to be appreciated that the method may also comprise capturing one or more images of the surface using the camera. The method may additionally comprise processing the one or more captured images. In particular, the method may comprise only capturing images of the surface and/or processing the captured images in response to receiving an indication from the apparatus that the position of the body relative to the surface meets the pre-defined criteria, and/or in response to not receiving an indication from the apparatus that the position of the body relative to the surface does not meet the pre-defined criteria.

### BRIEF DESCRIPTION OF THE SEVERAL VIEWS OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a perspective view of a handheld scanning apparatus;

FIG. 2 is an internal view of part of a handheld scanning apparatus;

FIG. 3 is a view of the apparatus of FIG. 2 in one position; and

FIG. 4 is a view of the apparatus of FIG. 2 in another position.

### DETAILED DESCRIPTION OF THE INVENTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

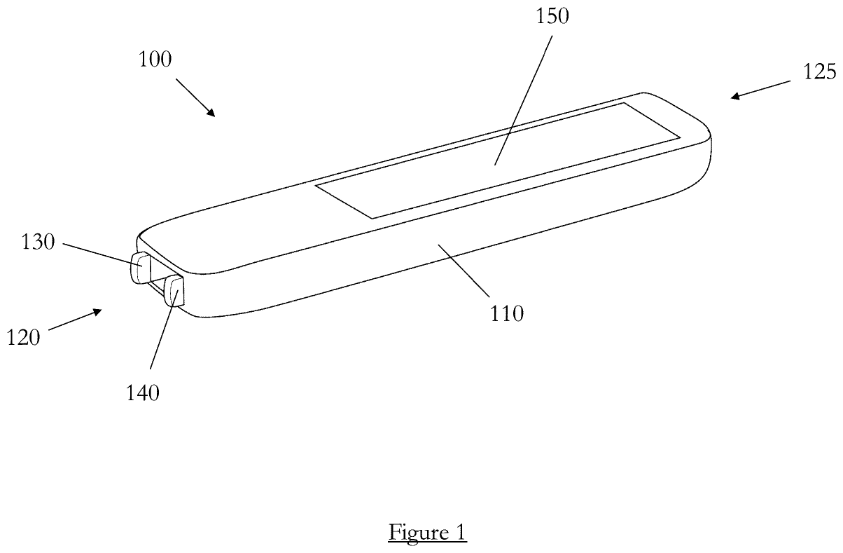

FIG. 1 is a perspective view of a handheld scanning apparatus 100. The handheld scanning apparatus 100 comprises a body 110 configured to be held easily and comfortably in the hand of a user. The body 110 is elongate in shape, extending from a first end 120 to a second end 125 such that the distance between the first end 120 and the second end 125 (the longitudinal length) is substantially greater than the length of the body 110 measured in any direction perpendicular to the longitudinal length. The body may have a length of around 15 cm.

In use, the user holds the body 110 in their hand with the first end 120 of the body 110 closely adjacent, or in contact with, a surface comprising an image to be scanned, such as a page of text. They then move the body 110 across the surface, keeping the first end 120 closely adjacent or in contact with the surface. A digital camera (not shown) is arranged in the first end 120 of the body 110 with its optical axis parallel to the longitudinal length of the body 110 and the camera captures images of the surface as the body 110 is moved across the surface.

The captured images are then processed (e.g. by a processor) and an output signal is provided to the user. For example, where the image to be scanned comprises a page of text, the output signal may comprise an audio output so that the apparatus 100 effectively “reads” the text out loud to the user. Alternatively, or additionally, the output signal may comprise a graphic display that displays the text in a way that is easier for the user to read (e.g. magnified, or with a tinted background). In another example, the surface may comprise a page of text in a first language and the output signal may comprise an audio and/or graphic output of a translation of the text into a second language.

Processing the captured images may involve stitching the images together to form a larger image (such as a complete word), or processing each image individually. Processing the captured images may involve carrying out optical character recognition to identify text in the captured images. The processing of the captured images may be carried out by a processor within the body 110 or by a remote processor (i.e. outside of the body 110).

The apparatus 100 shown in FIG. 1 comprises a display screen 150, which may comprise an LED display, an LCD display, an OLED display or any similar type of display. The display screen may be used to provide a graphical output relating to the image scanned by the camera, as described above. Alternatively, or additionally, the display screen 150 may comprise a touch screen and may display menus and/or touch-sensitive controls for setting up and/or operating the handheld scanning apparatus 100.

However, in order that text is reliably and accurately recognised, the captured images must include complete characters (i.e. not clipped at the edge of the image) and the characters in each image should ideally be approximately the “right way up” to ensure correct processing (e.g. character recognition). It is therefore important that the user holds the body 110 in the optimal orientation relative to the surface, in use. For the apparatus 100 shown in FIG. 1, the body 110 is in the optimal orientation relative to the surface when either short edge of the display screen 150 is parallel to the plane of the surface.

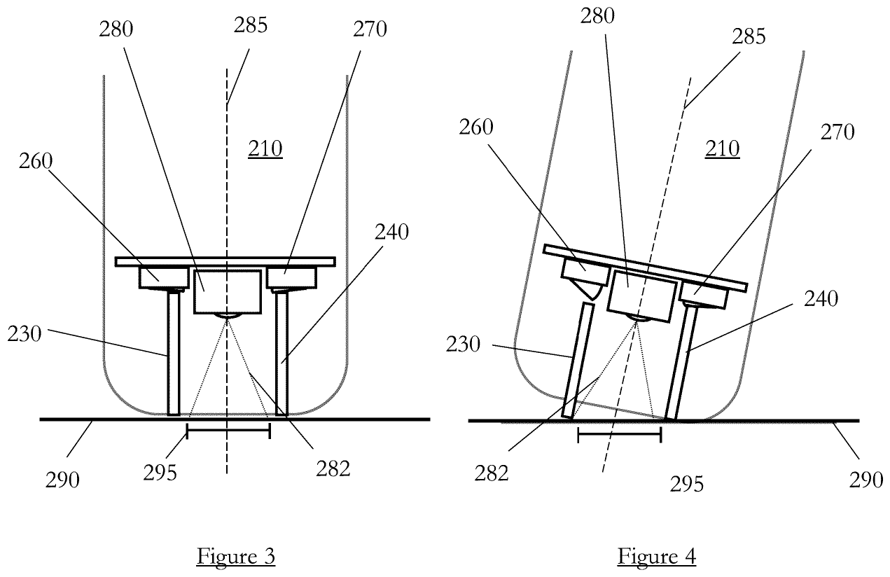

With reference to FIG. 1, in order to aid the user in holding the body 110 in this optimal orientation, two actuators 130, 140 are arranged in the body with an end portion of each actuator 130, 140 projecting from the first end 120 of the body 110. The projecting ends of the actuators 130, 140 form D-shaped tabs with their curved surfaces configured to make contact with the surface, in use. When the body 110 is in the optimal orientation relative to the surface, both end portions of the actuators 130, 140 will be in contact with the surface (as shown in FIG. 3). When the body 110 is not in the optimal orientation relative to the surface, one or both of the end portions of the actuators 130, 140 will not be in contact with the surface (as shown in FIG. 4).

The apparatus may provide the user with an indication that they are holding the body 110 in a sub-optimal orientation relative to the surface. The indication may comprise an audio, visual and/or haptic indication and, accordingly, the handheld scanning apparatus may comprise an output device (such as the display screen) for providing said indication. Additionally, if the apparatus 100 comprises a processor for processing the images captured by the camera, the processor may stop processing the images when the body 110 is in a sub-optimal orientation relative to the surface, so as to limit the use of power and computational resources.

Additional components may be present inside the body 110, such as a battery, one or more additional output devices/ports, a light source (e.g. an LED) configured to illuminate a region of the surface immediately adjacent the first end 120 of the body 110 and/or a communication means for communicating with a remote processor.

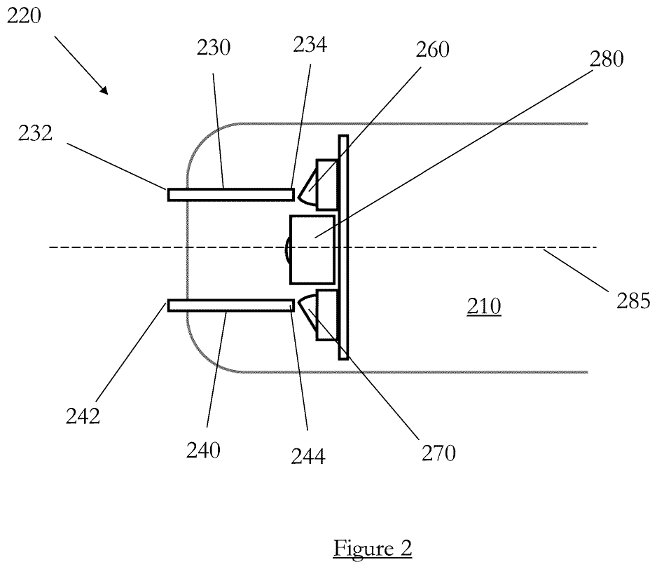

FIG. 2 is a cross-sectional view of a first end 220 of another handheld scanning apparatus. In this case, the two actuators are in the form of relatively thin, cylindrical prongs 230, 240 arranged partially within the body with their respective longitudinal lengths parallel to one another. A distal end 232 of a first prong 230 projects from the first end 220 of the body 210. Similarly, a distal end 242 of a second prong 240 projects from the first end 220 of the body 210. It is to be appreciated that, while the distal ends 232, 242 of the two prongs 230, 240 are shown as being flat, they may in fact be domed so as to minimise scratching/damage to a surface with which they make contact, in use.

The two prongs 230, 240 are configured to be independently moveable in a direction parallel to, and along, their longitudinal lengths so that the distance between each distal end 232, 242 and the first end 220 of the body 210 can vary independently. Each prong 230, 240 may be located in a groove, channel or guide (not shown) within the body 210 so that movement of the prongs 230, 240 is constrained to the direction parallel to their longitudinal lengths. One or more flanges and/or radial projections (not shown) may be present on the prongs 230, 240, configured to engage with corresponding projections provided on the groove, channel or guide to limit the movement of the prongs (e.g. to prevent them from falling out of the body).

In FIG. 2, the prongs 230, 240 are both shown projecting from the first end 220 of the body 210. A biasing means (not shown) may be present in order to ensure that the prongs 230, 240 always return to this position when their distal ends 232, 242 are not in contact with a surface.

A first microswitch 260 is arranged adjacent a proximal end 234 of the first prong 230 and a second microswitch 270 is arranged adjacent a proximal end 244 of the second prong 240. As shown in FIG. 2, when neither distal end 232, 242 of the prongs 230, 240 are in contact with a surface, the microswitches 260, 270 are not actuated.

The microswitches 230, 240 may be “push to make” or “push to break” type switches. Where a microswitch is of the “push to make” type, the microswitch is to be considered “actuated” when the switch contacts are engaged, thereby completing an electrical connection through the microswitch. Where a microswitch is of the “push to break” type, the microswitch is to be considered “actuated” when the switch contacts are disengaged, thereby breaking an electrical connection through the microswitch.

A camera 280 is arranged symmetrically between the two prongs 230, 240 with its optical axis 285 parallel to their longitudinal lengths.

FIG. 3 is a cross-sectional view of the internal arrangement shown in FIG. 2 in a first position relative to a surface 290. It can be assumed that the surface 290 comprises an image to be scanned. For example, the surface 290 may comprise text to be scanned. Furthermore, it can be assumed that the body 210 is being held in the hand of a user (not shown). With the body 210 held in this first position, both distal ends of the prongs 230, 240 are in contact with the surface 290. The force exerted on each of the prongs 230, 240 by the surface 290 has pushed the prongs 230, 240 all of the way into the body. Consequently, both microswitches 260, 270 have been actuated by the proximal ends of the prongs 230, 240. Although shown with both prongs fully retracted into the body, it is to be understood that actuation of both microswitches may be effected with both prongs still slightly projecting from the body.

For example, the first microswitches 260 may be actuated by the proximal end of the first prong 230 when the first prong 230 is pushed into the body beyond a first threshold distance, and the second microswitch 270 may be actuated by the proximal end of the second prong 240s when the second prong 240 is pushed into the body beyond a second threshold distance.

FIG. 4 is a cross-sectional view of the internal arrangement shown in FIG. 2 in a second position relative to a surface 290. With the body 210 held in this second position, the distal ends of each of the two prongs 230, 240 are at different distances from the first end of the body 210. In other words, the first prong 230 has either not been pushed into the body, or has only been pushed in a little way, such that the microswitch 260 has not been actuated. Conversely, the second prong 240 has been pushed into the body to the same extent as that shown in FIG. 3, and accordingly the microswitch 270 associated with this second prong has been actuated.

Consequently, only one microswitch 260 has been actuated by the distal ends of the prongs 230, 240. This situation may effect an indication to be provided to the user to warm them to reposition the device such that both prongs are pushed in and both microswitches are actuated.

This is because, with the body in the position relative to the surface 290 shown in FIG. 3, the camera is able to fully capture an image (for example as indicated by bracket 295). This is shown by the camera's field of view (denoted by the dotted lines 282), which is seen to cover both ends of the image. However, with the position shown in FIG. 4, the camera's field of view does not capture all of the image (295) as its ends are outside the field of view.

Furthermore, with reference to FIG. 3, viewed in the plane of the cross-section, the camera's optical axis 285 makes a right angle with the surface 290, thereby preventing any skewing/distorting of the captured images in a direction parallel to the plane of the cross-section.

By contrast, with reference to FIG. 4, as viewed in the plane of the cross-section, the camera's optical axis 285 is inclined at an acute angle to the surface 290. Consequently, the images captured by the camera will be skewed/distorted in a direction parallel to the plane of the cross-section. For example, if portion 295 contains a line of text, the height of the characters in the text relative to their width may appear distorted.

In this manner, the user is prompted by the device to consistently hold the pen, or body, at a position relative to the surface such that optimal image capture and subsequent processing is effected.

What is claimed is:

1. A handheld scanning apparatus for scanning images and for converting the images into a different format, the handheld scanning apparatus comprising:
a body;
a camera arranged in the body configured to scan images, in use, when a first end of the body is held closely adjacent, or in contact with, a surface comprising an image to be scanned;
two actuators, each having a distal end projecting from the first end of the body, the distal end arranged to contact the surface, in use, when the body is held closely adjacent, or in contact with, the surface, each of the actuators independently moveable relative to the body in dependence of the distance of the first end of the body from the surface;
a position detector for determining the position of each of the actuators relative to the body; and
an indicator configured to provide an indication that the position of the body relative to the surface, in use, either meets, or does not meet, pre-defined criteria, on the basis of the position of each of the actuators relative to the body.

2. The handheld scanning apparatus of claim 1, wherein the position detector comprises two microswitches, a first microswitch actuated by the movement of one of the two actuators towards the body beyond a first threshold distance, and a second microswitch actuated by the movement of the other of the two actuators towards the body beyond a second threshold distance.

3. The handheld scanning apparatus of claim 2, wherein the pre-defined criteria comprise the requirement that both microswitches are actuated.

4. The handheld scanning apparatus of claim 2, wherein the first and second threshold distances are equal to one another or not equal to one another.

5. The handheld scanning apparatus of claim 2, wherein the first and second threshold distances are in the range 0.5 mm to 10 mm.

6. The handheld scanning apparatus of claim 5, wherein the first and second threshold distances are in the range 2 mm to 10 mm.

7. The handheld scanning apparatus of claim 1, wherein the indicator is configured to provide an indication in one or more of an audible, haptic, and visual manner.

8. The handheld scanning apparatus of claim 1, further comprising a display screen.

9. The handheld scanning apparatus of claim 1, further comprising a processor configured to process the images scanned by the camera.

10. The handheld apparatus of claim 9, wherein the processor is further configured to determine whether the position of the body relative to the surface, in use, meets the predefined criteria.

11. The handheld scanning apparatus of claim 9, wherein the processor is configured to only process the images scanned by the camera when the position of the body relative to the surface, in use, meets the pre-defined criteria.

12. The handheld scanning apparatus of claim 1, wherein each actuator comprises a relatively thin prong, and wherein each prong is arranged with its longitudinal length parallel to the optical axis of the camera, and configured to move relative to the body in a direction parallel to the optical axis of the camera.

13. The handheld scanning apparatus of claim 12, wherein the camera is arranged in the body between the two prongs.

14. The handheld scanning apparatus of claim 12, further comprising biasing means for biasing the prongs outwardly away from body.

15. The handheld scanning device of claim 14, wherein the biasing means comprise at least one spring.

16. The handheld scanning apparatus of claim 1, wherein the position detector comprises a first linear displacement sensor actuated by the movement of one of the two actuators towards the body beyond a first threshold distance, and a second linear displacement sensor actuated by the movement of the other of the two actuators towards the body beyond a second threshold distance.

17. A method of scanning images and converting the images into a different format, the method comprising the steps of: providing the handheld scanning apparatus of claim 1; holding the body of the apparatus closely adjacent, or in contact with, a surface comprising an image; the apparatus determining the position of each of the actuators relative to the body; and the apparatus providing an indication that the position of the body relative to the surface either meets, or does not meet, pre-defined criteria, on the basis of the position of each of the actuators relative to the body.
